(19) United States
(12) Patent Application Publication
(10) Pub. No.: US 2013/0132101 A1
(43) Pub. Date: May 23, 2013

(54) System and Method for Improving Performance of a Behavioral Targeting Model

(71) Applicants: Craig W. Kowalchuck, Aurora (CA); Sheldon H. Smith, Toronto (CA); David Diamond, New York, NY (US); Raymond Ferris, Toronto (CA)

(72) Inventors: Craig W. Kowalchuck, Aurora (CA); Sheldon H. Smith, Toronto (CA); David Diamond, New York, NY (US); Raymond Ferris, Toronto (CA)

(73) Assignee: Twenty-Ten, Inc., Toronto (CA)

(21) Appl. No.: 13/298,324

(22) Filed: Nov. 17, 2011

(51) Int. Cl. G06Q 30/02

(52) U.S. Cl. 705/1.1

(57) ABSTRACT

A system. The system includes a computing device and a combiner module. The computing device includes a processor. The combiner module is communicably connected to the processor, and is configured to combine a score generated by a behavioral targeting model with a score generated by an attitudinal targeting model.

### CROSS-REFERENCE TO RELATED APPLICATION

This application is related to U.S. patent application Ser. No. 13/167,899, to U.S. patent application Ser. No. 13/020,967, to U.S. patent application Ser. No. 12/869,441, to U.S. patent application Ser. No. 12/340,244, now U.S. Pat. No. 7,835,940, to U.S. patent application Ser. No. 10/821,516, now U.S. Pat. No. 7,742,072, and to U.S. patent application Ser. No. 09/511,971, now abandoned.

### BACKGROUND

This application discloses an invention which is related, generally and in various embodiments, to a system and method for improving performance of a behavior targeting model.

In the quest for new business opportunities, there has been a growing proliferation of products and services seeking to more relevantly satisfy consumer needs. This has heightened competition and furthered a desire by direct marketers to look for tools that can more precisely identify optimal groups of consumers who would be more likely to purchase a given product or service. Various attempts to satisfactorily meet this desire have included the use of behavior-based targeting methods.

In traditional behavioral-based targeting models, a given model is typically generated based on an analysis of the relationship between (1) a responder to and/or a transactor of one or more direct marketing campaigns and (2) a set of independent or predictor variables such as, for example, gender, income, age, home-ownership, parenthood, education, geographic location, ethnicity, etc. The generated model may be utilized to identify prospects who are more likely to meet a desired responder/transactor profile.

In general, methods employed for generating behavioral-based targeting models use historical information (e.g., what was mailed, who responded, how much was spent, etc.) which is generally available from one or more databases to determine what type of consumer had previously responder and/or purchased a specific product/service category or brand from a direct marketing offer. Such, information includes a plurality of data variables for each of the potential consumers, including behavioral variables and non-attitudinal variables.

Linear regression and logistic regression are the two most commonly utilized statistical techniques employed for behavioral-based modeling. In some applications, linear regression is utilized to fit a linear relationship between a continuous type (having a value from zero to infinity) dependent variable (e.g., past expenditure level of a consumer) and a set of independent or predictor variables. Fitting the linear relationship allows for (1) a determination of the underlying relationship between the dependent variable and the key independent variables and (2) the prediction of new values for the dependent variable. Using linear regression, if catalogs are mailed to a plurality of consumers from a given database, the predicted purchase amount for each of these consumers can be predicted by a number of independent variables such as, for example, (1) how long the consumer has been a customer of the company associated with the catalog, (2) whether the consumer has ever purchased anything through the company's website, (3) the number of people who live in the consumer's home, (4) whether the consumer owns the home or rents the home, etc. For this catalog example, a linear regression model may be generated to predict a consumer's spending propensity based on the given independent variables. The generated model may then be utilized to select other consumer prospects who in the future would be most likely to spend higher total amounts for items in the catalog.

In logistic regression, the dependent variable is dichotomous (e.g., Yes=1 or event of interest, No=0 or no event of interest). Logistic regression is utilized to predict the likelihood of an event based on a set of independent variables. For example, if a bank would like to know how likely a customer is to respond to a particular offer based on a set of, independent variables like debt-income ratio, mortgage, account type, gender, age, balance, etc., logistic regression may be utilized to predict the likelihood.

Although behavioral-based targeting models can perform better than simpler traditional approaches (e.g., only using demographic factors) in more precisely identifying optimal groups of consumers, the behavioral based models are less than optimal for identifying prospects who best meet a desired consumer profile.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system;

FIG. 2 illustrates various embodiments of a computing system of the system of FIG. 1;

FIG. 3 illustrates various embodiments of a combiner module of the system of FIG. 1;

FIG. 4 illustrates various embodiments of another system;

FIG. 5 illustrates various embodiments of a mapping module of the system of

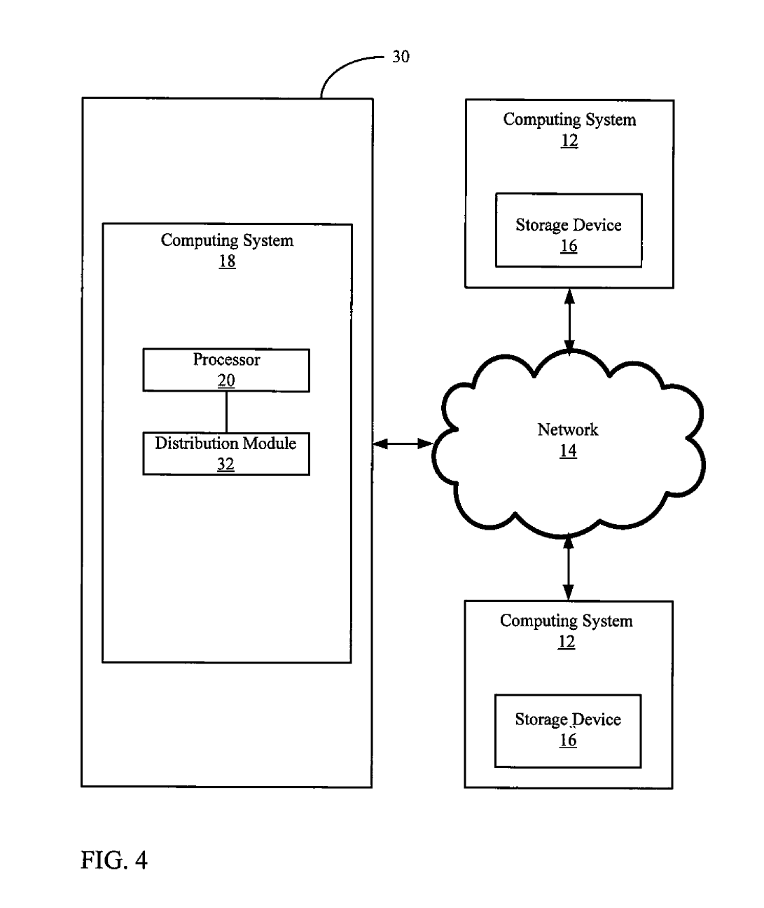

FIG. 4;

FIG. 6 illustrates various embodiments of yet another system; and

FIG. 7 illustrates various embodiments of even yet another system.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

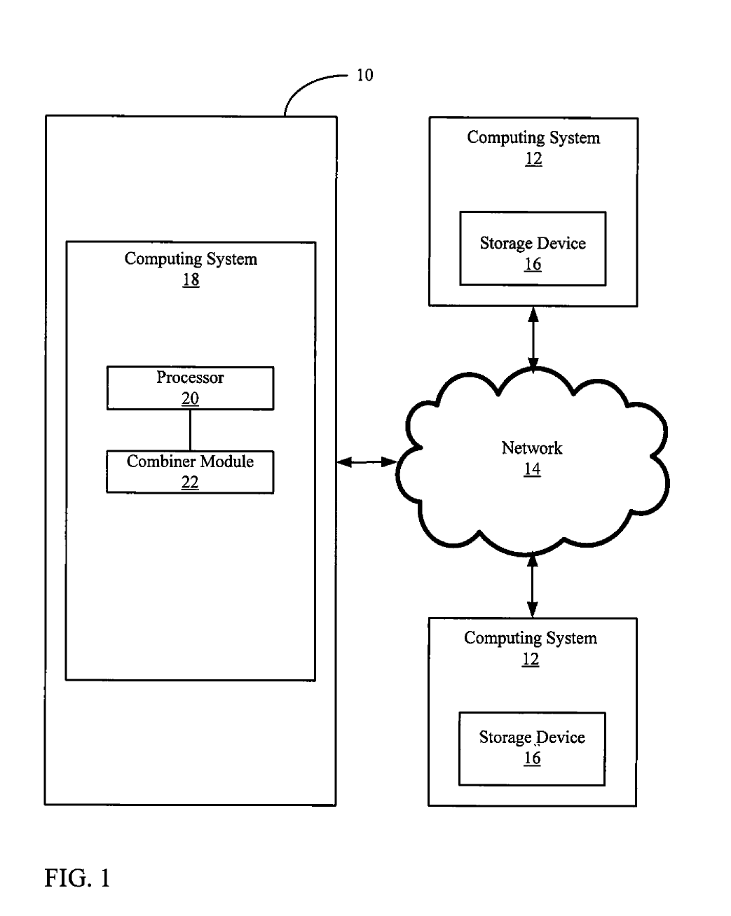

FIG. 1 illustrates various embodiments of a system 10. The system 10 is configured to identify prospects who best meet a desired consumer profile. The desired consumer profile may be, for example, a desired responder profile (e.g., a consumer who is more likely to respond to a given catalog mailing), a desired transactor profile (e.g., a consumer who is more likely to spend a higher total amount for items in the catalog), etc. As shown in FIG. 1, the system 10 may be communicably connected to a plurality of computing systems 12 via one or more networks 14. Each of the one or more networks 14 may include any type of delivery system including, but not limited to, a local area network (e.g., Ethernet), a wide area network (e.g. the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. A given network 14 may include elements, such as, for example, intermediate nodes, proxy servers, routers, switches, and adapters configured to direct and/or deliver data. In general, the system 10 may be structured and arranged to communicate with the computing systems 12 via the one or more networks 14 using various communication protocols (e.g., HTTP, TCP/IP, UDP, WAP, WiFi, Bluetooth) and/or to operate within or in concert with one or more other communications systems.

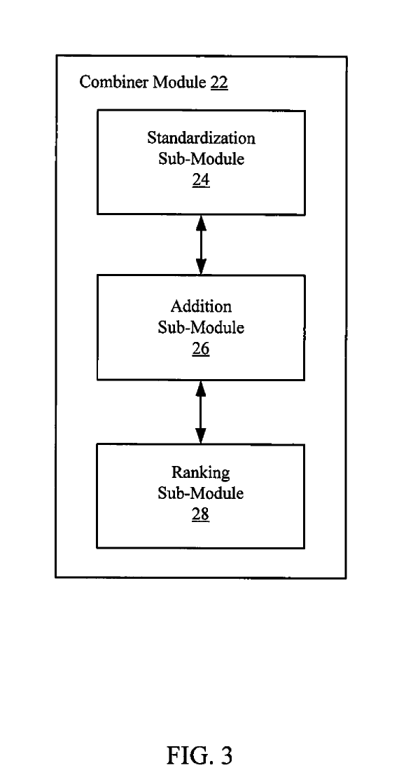

Each of the computing systems 12 may include any number of computing devices communicably connected to one another. According to various embodiments, the attitudinal model and/or the behavioral model may reside at one or more of the computing systems 12. For example, the behavioral model may reside at a first one of the computing systems 12 and the attitudinal model may reside at a second one of the computing systems 12. According to various embodiments, the attitudinal model and/or the behavioral model may be generated by one or more of the computing systems 12. For example, one or more of the computing devices 12 may include any of the “targeting engines” described in U.S. patent application Ser. No. 13/167,899 (e.g., the modules of the system 10 shown in FIG. 1 thereof, U.S. patent application Ser. No. 13/020,967 (e.g., the modules of the system 30 shown in FIG. 3 thereof), in U.S. patent application Ser. No. 12/869,441 (e.g., the modules of the system 10 shown in FIG. 1 thereof), in U.S. patent application Ser. No. 09/511,971, in U.S. Pat. No. 7,835,940 and in U.S. Pat. No. 7,742,072, and any of the above-described targeting engines and/or combinations thereof may be utilized to generate the attitudinal model. The contents of the above-referenced U.S. Patent Applications are hereby incorporated by reference in their entirety. Each of the patents/patent applications listed above are assigned to the assignee of the instant application.

As the system 10 is communicably connected to the computing systems 12, the outputs of any behavioral and/or attitudinal models residing at the computing systems 12 may be accessed by the system 10. Conceptually, the outputs of the behavioral and/or attitudinal models can be thought of as scores, with the scores having relative ordinal values. The ordinal values may be utilized to rank consumers on a database based on their likelihood to reflect a desired target profile. Although only two computing systems 12 are shown in FIG. 1, it will be appreciated that the system 10 may be communicably connected to any number of such computing systems 12.

The system 10 may also be communicably connected to a plurality of storage devices 16. According to various embodiments, the system 10 is communicably connected to the storage devices 16 via the network 14. As shown in FIG. 1, according to various embodiments, each respective storage device 16 may form a portion of each respective computing system 12.

One or more of the storage devices 16 may include a database having information regarding potential consumers, and such information may be present for any number of potential consumers. For example, for one of the storage devices 16, the database may include information for approximately 50,000,000 potential consumers, wherein the information may include a plurality of data variables (e.g., behavioral and demographic/non-attitudinal) for each of the potential consumers, and wherein the information is appended to individual records/rows of data in a database table. The consumer data variables may relate to many different types of data. Behavioral variables reflect actions which have been taken by consumers in the past, as well as self-reported propensities to take certain actions in the future. Non-attitudinal variables are objective variables of each consumer that are not based on the purchasing attitudes of the consumer. Such non-attitudinal variables include, for example, gender, income, age, home-ownership, parenthood, education, geographic location, ethnicity, etc.

For another of the storage devices 16, the database may include the same information but for fewer potential consumers (e.g., approximately 32,000,000 consumers). Each of the respective databases may be a company's private database (e.g., a Time Inc. database, a Target Corporation database, etc.) or a database maintained by a third party service provider.

According to various embodiments, as described in more detail hereinbelow, the system 10 may also be configured to generate one or more behavioral targeting models and/or one or more attitudinal targeting models. As the system 10 is communicably connected to the storage devices 16, lists of potential consumers, including information associated with the consumers, may be accessed by the system 10. Thus, for embodiments where the system 10 is also configured to generate behavioral and/or attitudinal targeting models, the models may be generated based on information available from the computing systems 12 and/or storage devices 16. Although only two storage devices 16 are shown in FIG. 1, it will be appreciated that the system 10 may be communicably connected to any number of such storage devices 16, with each storage device 16 including any number of such databases.

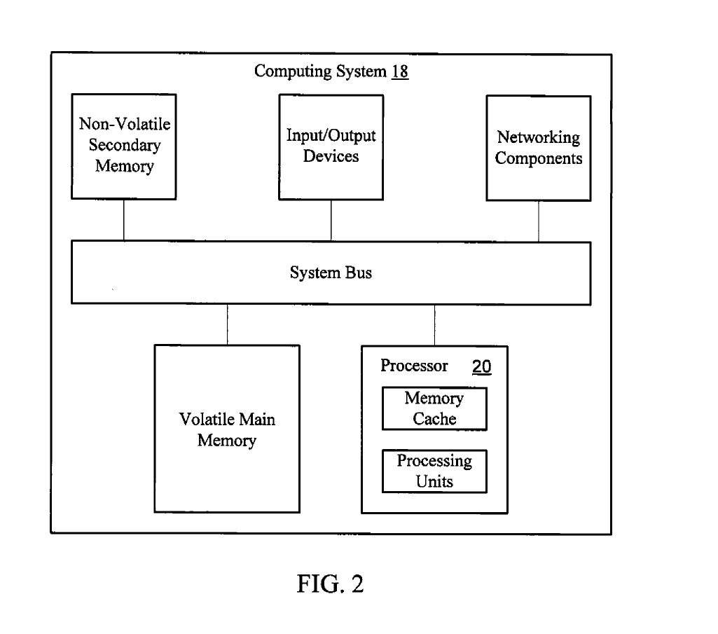

The system 10 includes a computing system 18. The computing system 18 may include any suitable type of computing device (e.g., a server, a desktop, a laptop, etc.) that includes at least one processor 20. Various embodiments of the computing system 18 are described in more detail hereinbelow with respect to FIG. 2.

FIG. 2 illustrates various embodiments of the computing system 18. The computing system 18 may be embodied as one or more computing devices, and includes networking components such as Ethernet adapters, non-volatile secondary memory such as magnetic disks, input/output devices such as keyboards and visual displays, volatile main memory, and a processor 20. Each of these components may be communicably connected via a common system bus. The processor 20 includes processing units and on-chip storage devices such as memory caches.

According to various embodiments, the computing system 18 includes one or more modules which are implemented in software, and the software is stored in non-volatile memory devices while not in use. When the software is needed, the software is loaded into volatile main memory. After the software is loaded into volatile main memory, the processor 20 reads software instructions from volatile main memory and performs useful operations by executing sequences of the software instructions on data which is read into the processor 20 from volatile main memory. Upon completion of the useful operations, the processor 20 writes certain data results to volatile main memory.

Returning to FIG. 1, the system 10 also includes a combiner module 22 communicably connected to the processor 20. The combiner module 22 is configured to combine outputs from a behavioral targeting model with outputs from a corresponding attitudinal targeting model. By utilizing the combined outputs of a behavioral targeting model and a corresponding attitudinal model, the results obtained by the system 10 are generally better (e.g., better responses, better spends, etc.) than results generated solely by a traditional behavioral targeting model. For example, the response rate for various direct marketing initiatives was approximately 10-19% higher when comparing the top decile results of the system 10 with the top decile results of the traditional behavioral targeting model.

FIG. 3 illustrates various embodiments of the combiner module 22. As shown in FIG. 3, the combiner module 22 may include a standardization sub-module 24, an addition sub-module 26, and a ranking sub-module 28. Each of the sub-modules 24-28 may be communicably connected to the processor 20 and to each other.

The standardization sub-module 24 is configured to statistically standardize the respective outputs (“scores”) generated by a behavioral targeting model and a corresponding attitudinal targeting model (e.g., one behavioral targeting model score and one attitudinal targeting model score for each consumer on a database). For embodiments where more than one score is generated for each consumer (due to more than one targeting engine algorithm being utilized with the behavioral targeting model and/or the attitudinal targeting model), the standardization sub-module 24 is configured to statistically standardize each of the generated scores. Additionally, according to various embodiments, the standardization sub-module 24 is further configured to weight the standardized scores according to desired target profile.

The addition sub-module 26 is configured to add corresponding standardized scores from the behavioral targeting model and the attitudinal targeting model (e.g., one score from the behavioral targeting model and one score from the attitudinal targeting model) for a given consumer to generate a composite score for the consumer. For embodiments where more than one score is generated for each consumer by the behavioral targeting module and/or more than one score is generated for each consumer by the attitudinal targeting module, the addition sub-module 26 may add any combination of the scores together for a given consumer to generate the composite score for that consumer. Thus it will be appreciated that the addition sub-module 26 may generate more than one composite score for a given consumer.

The ranking sub-module 28 is configured to rank the consumers based on the respective composite scores generated by the addition sub-module 26. According to various embodiments, the respective composite scores are ranked from lowest to highest. According to other embodiments, the respective composite scores are ranked from highest to lowest. For embodiments where more than one composite score is generated for each consumer by the addition sub-module 26, the ranking sub-module 28 may generate any number of different rankings. For example, if two composite scores are generated for each consumer, the ranking sub-module 28 may generate (1) a first ranking based on the first set of composite scores and (2) a second ranking based on the second set of composite scores. Based on the rankings of the composite scores (and by logical extension the rankings of the consumers associated with the composite scores), the system 10 can readily identify those consumers who best meet a desired consumer profile.

The combiner module 22 and each of the sub-modules 24-28 may be implemented in hardware, firmware, software and combinations thereof. For embodiments utilizing software, the software may utilize any suitable computer language (e.g., C, C++, Java, JavaScript, Visual Basic, VB Script, Delphi) and may be embodied permanently or temporarily in any type of machine, component, physical or virtual equipment, storage medium, or propagated signal capable of delivering instructions to a device. The combiner module 22 (e.g., software application, computer program) and each of the sub-modules 24-28 may be stored on a computer-readable medium (e.g., disk, device, and/or propagated signal) such that when a computer reads the medium, the functions described herein-above are performed. According to various embodiments, the above-described functionality of the combiner module 22 and sub-modules 24-28 may be combined into fewer modules, distributed differently amongst the sub-modules, spread over additional sub-modules, etc.

FIG. 4 illustrates various embodiments of a system 30. The system 30 is configured to identify prospects who best meet a desired consumer profile. The system 30 is similar to the system 10 of FIG. 1, but is different in that the computing system 18 includes a distribution module 32 in lieu of (or in addition to) the combiner module 22. The distribution module 32 is communicably connected to the processor 20 and is configured to associate outputs from a behavioral targeting model with outputs from a corresponding attitudinal targeting model. According to various embodiments, the distribution module 32 may determine the likelihood that respective consumers (who are on a database) will respond to a direct marketing campaign based On outputs of a behavioral targeting model and outputs of a corresponding attitudinal targeting model. By utilizing the likelihoods determined based on both behavioral targeting model outputs and attitudinal targeting model outputs , the results obtained by the system 30 are generally better (e.g., better responses, better spends, etc.) than results generated solely by a traditional behavioral targeting model.

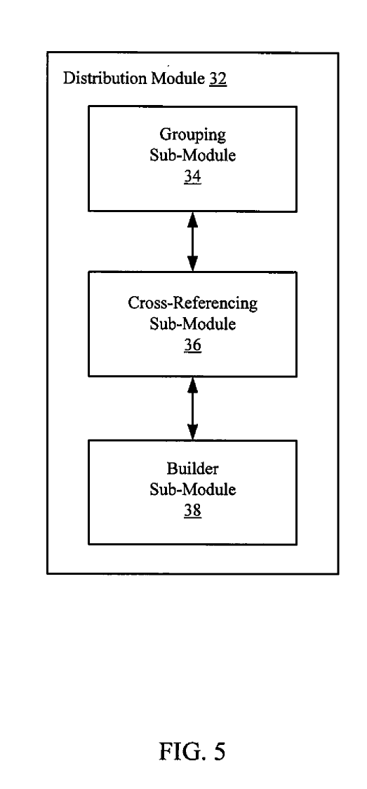

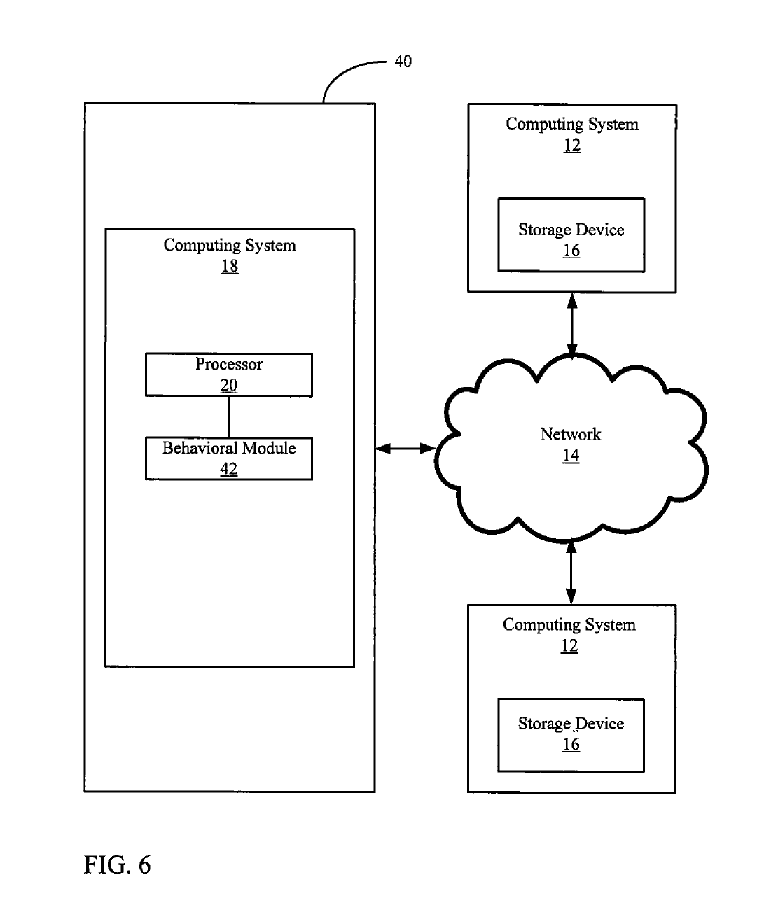

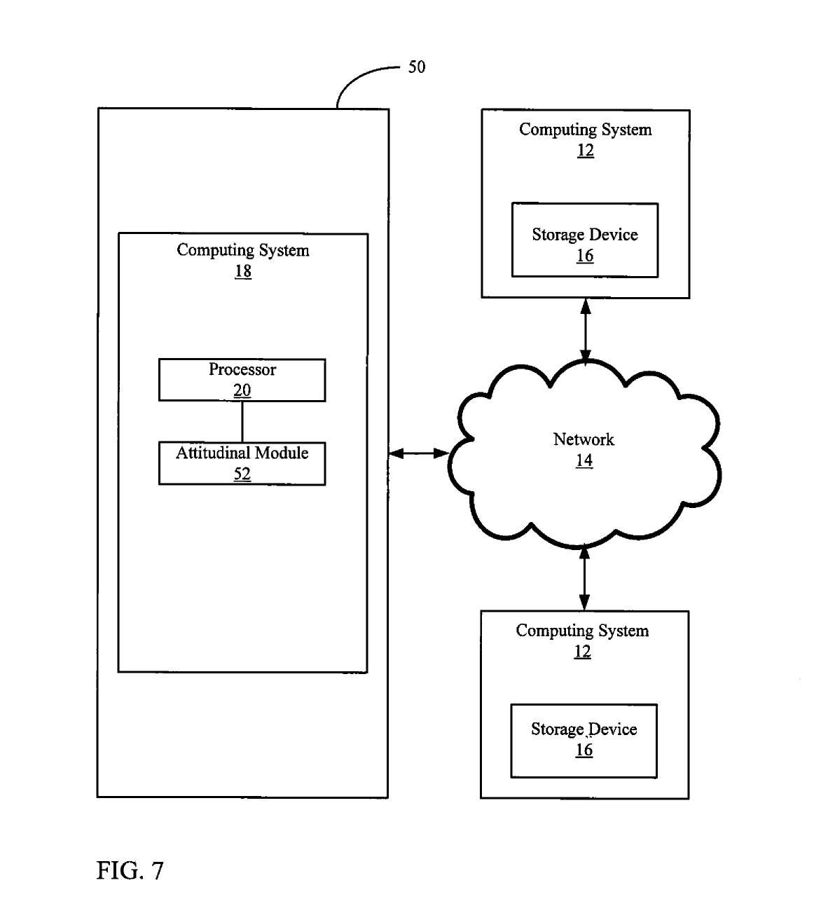

FIG. 5 illustrates various embodiments of the distribution module 32. As shown in FIG. 5, the distribution module 32 may include a grouping sub-module 34, a cross-referencing sub-module 36, and a builder sub-module 38. Each of the sub-modules 34-38 may be communicably connected to the processor 20 and to each other.

The grouping sub-module 34 is configured to group the outputs of a given behavioral targeting model (e.g., one “behavioral” output for each consumer in the database) into a plurality of subgroups based on the respective outputs (i.e., “behavioral scores”), The grouping sub-module 34 may group the behavioral scores into any number of subgroups. For example, according to various embodiments, the grouping sub-module 34 may group the behavioral scores into ten subgroups (e.g., deciles) based on the behavioral scores. For this example, the top 10% of the behavioral scores may be grouped into the first decile, the next 10% of the behavioral scores (i.e., the rest of the top 20%) may be grouped into the second decile, the next 10% of the behavioral scores (i.e., the rest of the top 30%) may be grouped into the third decile, and so on until all of the behavioral scores have been grouped.

Similarly, the grouping sub-module 34 is also configured to group the outputs of a given attitudinal targeting model (e.g., one “attitudinal” output for each consumer in the database) into a plurality of subgroups based on the respective outputs (i.e., “attitudinal scores”). The grouping sub-module 34 may group the attitudinal scores into any number of subgroups. For example, according to various embodiments, the grouping sub-module 34 may group the attitudinal scores into ten subgroups (e.g., deciles) based on the attitudinal scores. For this example, the top 10% of the attitudinal scores may be grouped into the first decile, the next 10% of the attitudinal scores (i.e., the rest of the top 20%) may be grouped into the second decile, the next 10% of the attitudinal scores (i.e., the rest of the top 30%) may be grouped into the third decile, and so on until all of the attitudinal scores have been grouped.

The cross-referencing sub-module 36 is configured to cross-reference each consumer's behavioral score and attitudinal score to determine the relative placement of each consumer within a matrix defined by the behavioral scores (e.g., columns) and the attitudinal scores (e.g., rows). For embodiments where the grouping sub-module 34 groups the behavioral scores into ten behavioral deciles and the attitudinal scores into ten attitudinal deciles, a given consumer can be “placed” within a given cell (i.e., associated with a given cell) of a 10×10 matrix based on the consumer's behavioral and attitudinal scores. For example, for a given consumer, if the consumer's behavioral score is in the first behavioral decile and the consumer's attitudinal score is in the fourth attitudinal decile, the consumer may be placed in a cell defined by the first column and the fourth row of the 10×10 matrix (i.e., cell₁₄). Upon the completion of the cross-referencing, all of the consumers on the database will be associated with particular cells of the matrix and the system 30 recognizes how many consumers are in each of the respective cells.

As the database already includes information regarding which of the consumers in the database responded to a previous random mail out and/or the amount that each of the consumers spent in response to the previous random mail out, the cross-referencing sub-module 36 may also be configured to determine an average response rate and/or an average spend amount for each column of the matrix (e.g., each behavioral decile), for each row of the matrix (e.g., each attitudinal decile), and for each cell of the matrix. For example, for a given direct marketing campaign, based on the behavioral targeting model utilized to generate the behavioral scores and the attitudinal model utilized to generate the attitudinal scores, the cross-referencing sub-module may determine that the consumers in the first column of the matrix had an average response rate of 3.17%, that the consumers in the first row of the matrix had an average response rate of 2.54%, and the consumers in the cell defined by the first column and the first row of the matrix (i.e., cell₁₁) had an average response rate of 3.55%.

The builder sub-module 38 is configured to identify which consumers on the database are to be included in the direct marketing campaign. In general, as most direct marketing campaigns are intended to be directed to a certain number of potential targets, at least some of the consumers to be included in the campaign are not associated with the cell defined by the first column and the first row of the matrix. According to various embodiments, the builder sub-module 38 builds a list of consumers to be included in the direct marketing campaign by including consumers from the cells which have the highest percentage of consumers who are likely to respond to the direct marketing campaign. Typically, the builder sub-module 38 will first include the consumers associated with the cell defined by the first column and the first row of the matrix (e.g., cell₁₁), then include the consumers associated with one or more of the cells which are contiguous to cell₁₁(e.g., cell₁₂ and/or cell₂₁), then include the consumers associated with the cells which are contiguous to cell₁₂ and/or cell₂₁, and so on until the desired number of prospective consumers is reached.

Once the builder sub-module 38 completes the list, the consumers on the list may be targeted by the direct marketing campaign. Since the list generated by the builder sub-module is based on both behavior scores and attitudinal scores, the results obtained by the system 30 are generally better (e.g., better responses, better spends, etc.) than results generated solely by a traditional behavioral targeting model. For example, according to one simulation, the average spend for consumers in the first behavioral decile was $3.39 whereas the average spend for consumers in cell₁₁ (the first behavioral decile and the first attitudinal decile) was $3.97, an increase of approximately 17%.

The distribution module 32 and each of the sub-modules 34-38 may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The distribution module 32 (e.g., software application, computer program) and each of the sub-modules 34-38 may be stored on a computer-readable medium (e.g., disk, device, and/or propagated signal) such that when a computer reads the medium, the functions described herein-above are performed. According to various embodiments, the above-described functionality of the distribution module 32 and sub-modules 34-38 may be combined into fewer modules, distributed differently amongst the sub-modules, spread over additional sub-modules, etc.

FIG. 6 illustrates various embodiments of a system 40. The system 40 is configured to utilize an output of an attitudinal targeting model as an additional independent variable to be utilized in the generation of a behavioral targeting model. The system 40 is similar to the system 10 of FIG. 1 and to the system 30 of FIG. 4, but is different in that the computing system 18 includes a behavioral module 42 in lieu of (or in addition to) the combiner module 22 and/or the distribution module 32.

According to various embodiments, the attitudinal targeting model may be generated by one or more of the computing systems 12. For example, one or more of the computing systems 12 may include any of the “targeting engines” described in U.S. patent application Ser. No. 13/167,899 (e.g., the modules of the system 10 shown in FIG. 1 thereof, U.S. patent application Ser. No. 13/020,967 (e.g., the modules of the system 30 shown in FIG. 3 thereof), in U.S. patent application Ser. No. 12/869,441 (e.g., the modules of the system 10 shown in FIG. 1 thereof), in U.S. patent application Ser. No. 09/511,971, in U.S. Pat. No. 7,835,940 and in U.S. Pat. No. 7,742,072, and any of the above-described targeting engines and/or combinations thereof may be utilized to generate the attitudinal targeting model. As the system 40 is communicably connected to the one or more computing systems 12, the system 40 may receive the outputs/scores of the attitudinal targeting model from the one or more computing systems 12.

The behavioral module 42 is configured similar to a traditional behavioral targeting model. However, whereas a traditional behavioral targeting model utilizes independent variables such as, for example, demographics, hobbies, interests, vehicle, etc. to develop a model which identifies consumers who meet a desired consumer profile, the behavioral module 42 is configured to utilize a “score” from an attitudinal targeting model as an additional independent variable (in addition to the independent variables typically utilized in traditional behavioral targeting models) to generate a “modified” behavioral targeting model which better identifies consumers who best meet a desired consumer profile. By including an attitudinal component into the functionality of the behavioral module 42, the results generated from the system 40 are generally better than results generated solely by a traditional behavioral targeting model.

The behavioral module 42 may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The behavioral module 42 (e.g., software application, computer program) may be stored on a computer-readable medium (e.g., disk, device, and/or propagated signal) such that when a computer reads the medium, the functions described herein-above are performed. According to various embodiments, the above-described functionality of the behavioral module 42 may be spread over additional submodules.

FIG. 7 illustrates various embodiments of a system 50. The system 50 is configured to utilize an output of a behavioral targeting model as an additional independent variable to be utilized to generate an attitudinal targeting model. The system 50 is similar to the system 10 of FIG. 1, the system 30 of FIG. 4 and the system 40 of FIG. 5, but is different in that the computing system 18 includes an attitudinal module 42 in lieu of (or in addition to) the combiner module 22, the distribution module 32 and/or the behavioral module 42.

According to various embodiments, the attitudinal module 52 may be configured similar to the “targeting engines” described in U.S. patent application Ser. No. 13/167,899 (e.g., the modules of the system 10 shown in FIG. 1 thereof, U.S. patent application Ser. No. 13/020,967 (e.g., the modules of the system 30 shown in FIG. 3 thereof), in U.S. patent application Ser. No. 12/869,441 (e.g., the modules of the system 10 shown in FIG. 1 thereof), in U.S. patent application Ser. No. 09/511,971, in U.S. Pat. No. 7,835,940 and in U.S. Pat. No. 7,742,072, but is different in that the attitudinal module 52 utilizes a “score” from a behavioral targeting model as an additional independent variable (in addition to the independent variables typically utilized in typical attitudinal targeting models) to generate a “modified” attitudinal targeting model which better identifies consumers who best meet a desired consumer profile. By including a behavioral component into the functionality of the attitudinal module 52, the results generated from the system 50 are generally better than results generated solely by a typical attitudinal targeting model.

According to various embodiments, the behavioral targeting model may be generated by one or more of the computing systems 12. As the system 50 is communicably connected to the one or more computing systems. 12, the system 50 may receive the outputs/scores of the behavioral targeting model from the one or more computing systems 12.

The attitudinal module 52 may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The attitudinal module 52 (e.g., software application, computer program) may be stored on a computer-readable medium (e.g., disk, device, and/or propagated signal) such that when a computer reads the medium, the functions described herein-above are performed. According to various embodiments, the above-described functionality of the attitudinal module 52 may be spread over additional submodules.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the described invention. For example, according to various embodiments, the computing system 18 may include more than one of the following modules: the combiner module 22, the distribution module 32, the behavioral module 42 and the attitudinal module 52. Accordingly, it is understood that the drawings and the descriptions herein are proffered only to facilitate comprehension of the invention and should not be construed to limit the scope thereof.

What is claimed is:

1. A system, comprising:
a computing device, wherein the computing device comprises a processor; and
a combiner module communicably connected to the processor, wherein the combiner module is configured to combine a score generated by a behavioral targeting model with a score generated by an attitudinal targeting model.

2. The system of claim 1, wherein the combiner module comprises:
a standardization sub-module communicably connected to the processor, wherein the standardization sub-module is configured to statistically standardize scores generated by the behavioral targeting model and scores generated by the attitudinal targeting model;
an addition sub-module communicably connected to the processor, wherein the addition sub-module is configured to add a standardized behavioral score to a standardized attitudinal score to generate a composite score; and
a ranking sub-module communicably connected to the processor, wherein the ranking sub-module is configured to rank composite scores generated by the addition sub-module.

3. A system, comprising:
a computing device, wherein the computing device comprises a processor; and
a distribution module communicably connected to the processor, wherein the distribution module is configured to associate a score generated by a behavioral targeting model with a score generated by an attitudinal targeting model.

4. The system of claim 3, wherein the distribution module comprises:
a grouping sub-module communicably connected to the processor, wherein the grouping sub-module is configured to group the following:
scores generated by the behavioral targeting model into a first plurality of subgroups; and
scores generated by the attitudinal targeting model into a second plurality of subgroups;
a cross-referencing sub-module communicably connected to the processor, wherein the cross-referencing sub-module is configured to cross-reference the scores generated by the behavioral targeting model and the scores generated by the attitudinal targeting model; and
a builder sub-module communicably connected to the processor, wherein the builder sub-module is configured to identify consumers to be included in a direct marketing campaign.

5. The system of claim 4, wherein the cross-referencing sub-module is further configured to determine an average response rate for at least one of the following:
consumers associated with one of the first plurality of subgroups; and
consumers associated with one of the second plurality of subgroups.

6. The system of claim 4, wherein the cross-referencing sub-module is further configured to determine an average spend amount for at least one of the following:
consumers associated with one of the first plurality of subgroups; and
consumers associated with one of the second plurality of subgroups.

7. A system, comprising:
a computing device, wherein the computing device comprises a processor; and
a behavioral module communicably connected to the processor, wherein the behavioral module is configured to utilize a score generated by an attitudinal targeting model as an additional independent variable to generate a predictive model.

8. A system, comprising:
a computing device, wherein the computing device comprises a processor; and
an attitudinal module communicably connected to the processor, wherein the attitudinal module is configured to utilize a score generated by a behavioral targeting model as an additional independent variable to generate a predictive model.
